(19) United States
(12) Patent Application Publication
(10) Pub. No.: US 2026/0366679 A1
(43) Pub. Date: Nov. 19, 2026

(54) GAS SUPPLY SYSTEM

(71) Applicant: TOYOTA JIDOSHA KABUSHIKI KAISHA, Toyota-shi (JP)

(72) Inventors: Yoshikatsu FUJIMURA, Toyota-shi (JP); Naoki Tomi, Kawasaki-shi (JP)

(73) Assignee: TOYOTA JIDOSHA KABUSHIKI KAISHA, Toyota-shi (JP)

(21) Appl. No.: 19/550,508

(22) Filed: Feb. 26, 2026

(30) Foreign Application Priority Data
May 16, 2025 (JP) 2025-082864

(51) Int. Cl. F17C 13/08; F17C 1/00; F17C 13/02

(52) U.S. Cl. CPC F17C 13/084; F17C 1/00; F17C 13/02; F17C 2205/0153; F17C 2270/0184

(57) ABSTRACT

A gas supply system includes: a gas supply pipe through which gas is supplied to a gas use destination; a gas tank; a tank attachment portion configured such that the gas tank is attachable and detachable; a moving device configured to move the gas tank attached to the tank attachment portion at least from a connection position to a detachment position; an operation portion configured to receive an operation by a user; and a control device configured to control an operation of the moving device. The connection position is a position where the gas tank is connectable to the gas supply pipe, and the detachment position is a position where the gas tank is detachable from the tank attachment portion. The control device is configured to control the moving device in response to an operation on the operation portion by the user.

### CROSS-REFERENCE TO RELATED APPLICATION

This application claims priority to Japanese Patent Application No. 2025-082864 filed on May 16, 2025. The disclosure of the above-identified application, including the specification, drawings, and claims, is incorporated by reference herein in its entirety.

### BACKGROUND

### 1. Technical Field

The technology disclosed in the present specification relates to a gas supply system.

### 2. Description of Related Art

Japanese Unexamined Patent Application Publication No. 2024-089965 (JP 2024-089965 A) discloses a gas supply system including a gas supply pipe through which gas is supplied to a gas use destination, a gas tank, a tank attachment portion configured such that the gas tank is attachable and detachable, a moving device that moves the gas tank attached to the tank attachment portion at least from a connection position to a detachment position, and a control device that controls the operation of the moving device.

### SUMMARY

In the gas supply system of JP 2024-089965 A, no consideration is given to the timing of detaching the gas tank from the tank attachment portion.

The present specification provides a technology for improving convenience for a user of a gas supply system.

In a first aspect of the present technology, a gas supply system may include: a gas supply pipe through which gas is supplied to a gas use destination; a gas tank; a tank attachment portion configured such that the gas tank is attachable and detachable; a moving device configured to move the gas tank attached to the tank attachment portion at least from a connection position to a detachment position; an operation portion configured to receive an operation by a user; and a control device configured to control an operation of the moving device. The connection position may be a position where the gas tank is connectable to the gas supply pipe. The detachment position may be a position where the gas tank is detachable from the tank attachment portion. The control device may be configured to control the operation of the moving device in response to an operation on the operation portion by the user.

With the above configuration, the moving device can move the gas tank to the detachment position in response to the operation on the operation portion by the user. Therefore, the user can detach the gas tank from the tank attachment portion at any time. Thus, the user convenience is improved.

In addition, the gas tank is prohibited from moving to the detachment position until the user operates the operation portion. This suppresses the occurrence of a case where the gas tank is accidentally detached from the tank attachment portion.

In a second aspect, in the first aspect described above, the control device may be configured to, in response to the operation on the operation portion by the user, disconnect the gas tank from the gas supply pipe when the gas tank is connected to the gas supply pipe, and control the moving device to move the gas tank to the detachment position when the gas tank is disconnected from the gas supply pipe.

With the above configuration, the gas tank can be moved stepwise in response to the operation on the operation portion by the user.

In a third aspect, in the second aspect described above, the control device may be configured to disconnect the gas tank from the gas supply pipe when a remaining amount in the gas tank is equal to or smaller than a predetermined amount, an ambient temperature of the gas tank is equal to or higher than a predetermined temperature, or a predetermined impact is applied to the gas tank in a state in which the gas tank is connected to the gas supply pipe.

It is not desirable to continue using the gas tank when the remaining amount in the gas tank is equal to or smaller than the predetermined amount, the ambient temperature of the gas tank is equal to or higher than the predetermined temperature, or the predetermined impact is applied to the gas tank. With the above configuration, the use of the gas tank can be suppressed when the remaining amount in the gas tank is equal to or smaller than the predetermined amount, the ambient temperature of the gas tank is equal to or higher than the predetermined temperature, or the predetermined impact is applied to the gas tank.

In a fourth aspect, in any one of the first to third aspects described above, the gas supply system may be mounted on a mobile body. The control device may be configured to restrict the operation of the moving device regardless of the operation on the operation portion by the user when at least one of a position, a speed, and an acceleration of the mobile body satisfies a predetermined condition.

It is not desirable for the gas tank to be detached from the tank attachment portion when the mobile body is located at a position different from a predetermined position. With the above configuration, it is possible to suppress the occurrence of a case where the gas tank is detached from the tank attachment portion when the mobile body is located at a position different from the predetermined position.

When the gas tank moves to the detachment position while the mobile body is traveling, the gas tank may be accidentally detached from the tank attachment portion. With the above configuration, it is possible to suppress the occurrence of a case where the gas tank is accidentally detached from the tank attachment portion.

In a fifth aspect, the gas supply system may include: a plurality of the gas tanks; a plurality of the tank attachment portions corresponding to the gas tanks, respectively; a plurality of the moving devices corresponding to the gas tanks, respectively; and a plurality of the operation portions corresponding to the gas tanks, respectively. The operation portions may be configured to receive operations by the user for the moving devices, respectively.

With the above configuration, the gas tanks can be detached individually.

### BRIEF DESCRIPTION OF THE DRAWINGS

Features, advantages, and technical and industrial significance of exemplary embodiments of the disclosure will be described below with reference to the accompanying drawings, in which like signs denote like elements, and wherein:

FIG. 1 is a schematic diagram of a vehicle 100 including a gas supply system 2 according to a first embodiment;

FIG. 2 is a flowchart of a switching process to be executed by a CPU 82;

FIG. 3 is a schematic diagram of a vehicle 300 including a gas supply system 202 according to a second embodiment;

FIG. 4 is a flowchart of a first switching process to be executed by the CPU 82; and

FIG. 5 is a flowchart of a second switching process to be executed by the CPU 82.

### DETAILED DESCRIPTION OF EMBODIMENTS

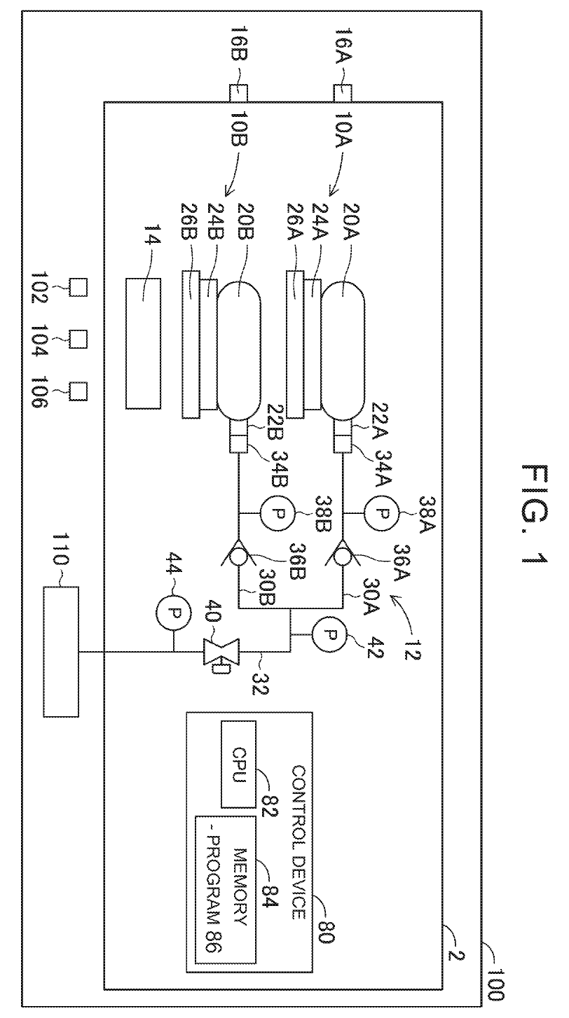

Referring to FIG. 1, a vehicle 100 will be described. The vehicle 100 includes a gas supply system 2, a speed sensor 102, an acceleration sensor 104, a position sensor 106, and a fuel cell 110. The speed sensor 102 detects the speed of the vehicle 100. The acceleration sensor 104 detects the acceleration of the vehicle 100. The position sensor 106 detects the position information (longitude, latitude, etc.) of the vehicle 100. In one example, the position sensor 106 is a GPS sensor. The fuel cell 110 generates electric power by causing oxygen gas to react with hydrogen gas, and supplies the electric power to a motor (not shown).

The gas supply system 2 includes gas tank units 10A, 10B, a gas supply pipe 12, switches 14A, 14B, and a control device 80.

The gas tank unit 10A includes a gas tank 20A, an on-off valve 22A, a support 24A, and a moving device 26A. The gas tank 20A is a cartridge tank. The gas tank 20A is filled with high-pressure hydrogen gas. The on-off valve 22A is connected to a boss of the gas tank 20A. The on-off valve 22A is a so-called "self-closing valve." The gas tank 20A is detachably attached to the support 24A. The moving device 26A moves the support 24A. The moving device 26A includes an actuator.

The gas tank unit 10B includes a gas tank 20B, an on-off valve 22B, a support 24B, and a moving device 26B. The gas tank 20B, the on-off valve 22B, the support 24B, and the moving device 26B have the same configurations as those of the gas tank 20A, the on-off valve 22A, the support 24A, and the moving device 26A, respectively.

The gas supply pipe 12 includes a first pipe 30A, a second pipe 30B, and a junction pipe 32.

The downstream end of the first pipe 30A is connected to the upstream end of the junction pipe 32. The gas tank 20A is connectable to the upstream end of the first pipe 30A. A push rod 34A is attached to the upstream end of the first pipe 30A. The push rod 34A opens or closes the on-off valve 22A of the gas tank 20A. The first pipe 30A is provided with a check valve 36A. A pressure sensor 38A is connected to the first pipe 30A between the upstream end of the first pipe 30A and the check valve 36A.

The downstream end of the second pipe 30B is connected to the upstream end of the junction pipe 32. The gas tank 20B is connectable to the upstream end of the second pipe 30B. A push rod 34B is attached to the upstream end of the second pipe 30B. The push rod 34B opens or closes the on-off valve 22B of the gas tank 20B. The second pipe 30B is provided with a check valve 36B. A pressure sensor 38B is connected to the second pipe 30B between the upstream end of the second pipe 30B and the check valve 36B.

The downstream end of the junction pipe 32 is connected to the fuel cell 110 outside the gas supply system 2. The junction pipe 32 is provided with a pressure reducing valve 40. The pressure reducing valve 40 reduces the pressure of the hydrogen gas supplied from the gas tanks 20A, 20B to a pressure suitable for the operation of the fuel cell 110. In the junction pipe 32, a pressure sensor 42 is connected between the upstream end of the junction pipe 32 and the pressure reducing valve 40, and a pressure sensor 44 is connected between the pressure reducing valve 40 and the downstream end of the junction pipe 32.

The control device 80 includes a CPU 82 and a memory 84. The memory 84 includes a volatile memory and a non-volatile memory. The CPU 82 operates based on a program 86 stored in the memory 84.

The CPU 82 can move the gas tank 20A by controlling the operation of the moving device 26A. The CPU 82 moves the gas tank 20A to a connection position, a disconnection position, and a detachment position. The connection position is a position within the gas supply system 2 where the gas tank 20A is connectable to the gas supply pipe 12 (specifically, the first pipe 30A). When the gas tank 20A is in the connection position, the on-off valve 22A of the gas tank 20A is pushed open by the push rod 34A. The detachment position is a position outside the gas supply system 2 where the gas tank 20A is detachable from the support 24A. That is, when the gas tank 20A is in the detachment position, a user can detach (remove) the gas tank 20A from the support 24A. The disconnection position is a position within the gas supply system 2 where the gas tank 20A is disconnected from the gas supply pipe 12 (specifically, the first pipe 30A). When the gas tank 20A is in the disconnection position, the on-off valve 22A of the gas tank 20A is not pushed open by the push rod 34A. That is, the disconnection position can be regarded as a position between the connection position and the detachment position. When the gas tank 20A is in the disconnection position, the user cannot detach (remove) the gas tank 20A from the support 24A. The disconnection position may be a position where the gas tank 20A is separated from the first pipe 30A.

The CPU 82 can move the gas tank 20B in the same way as that of the gas tank 20A by controlling the operation of the moving device 26B.

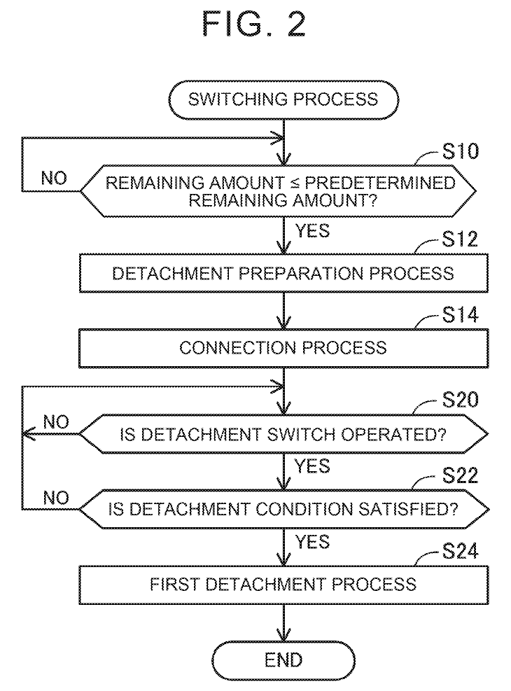

### Switching Process: FIG. 2

A switching process to be executed by the CPU 82 will be described with reference to FIG. 2. At the start of the process in FIG. 2, one of the gas tanks 20A, 20B is in the connection position, and the other is in the disconnection position. Hereinafter, the gas tank in the connection position and the gas tank in the disconnection position at the time of S10 will be referred to as "connected gas tank" and "disconnected gas tank," respectively.

In S10, the CPU 82 monitors whether the remaining amount in the connected gas tank is equal to or smaller than a predetermined remaining amount. In one example, when the pressure in the gas tank is equal to or lower than a predetermined pressure, the CPU 82 determines that the remaining amount is equal to or smaller than the predetermined remaining amount. When the remaining amount is equal to or smaller than the predetermined remaining amount, the CPU 82 determines "YES" in S10 and proceeds to S12.

In S12, the CPU 82 executes a detachment preparation process. Specifically, the CPU 82 controls the operation of the moving device corresponding to the connected gas tank to move the connected gas tank from the connection position to the disconnection position. As a result, the on-off valve of the connected gas tank is changed to a closed state, and the supply of the hydrogen gas from the connected gas tank to the fuel cell 110 is stopped. The CPU 82 also notifies the user that the remaining amount in the connected tank is equal to or smaller than the predetermined amount and that the detachment preparation process for the connected tank is completed.

In S14, the CPU 82 executes a connection process. Specifically, the CPU 82 controls the operation of the moving device corresponding to the disconnected gas tank to move the disconnected gas tank from the disconnection position to the connection position. As a result, the on-off valve of the disconnected gas tank is changed to an open state, and the supply of the hydrogen gas from the disconnected gas tank to the fuel cell 110 is started.

In S20, the CPU 82 monitors whether an operation is received on a detachment switch corresponding to the connected gas tank, that is, the gas tank that has been moved from the connection position to the disconnection position. When an operation is received on the detachment switch, the CPU 82 determines "YES" in S20 and proceeds to S22.

In S22, the CPU 82 determines whether a detachment condition is satisfied using the speed detected by the speed sensor 102, the acceleration detected by the acceleration sensor 104, and the position information detected by the position sensor 106. The detachment condition in the present embodiment is satisfied when the speed is equal to or lower than a predetermined speed, the acceleration is equal to or lower than a predetermined acceleration, and the position information indicates a predetermined position. In one example, the predetermined position is a hydrogen station. When the detachment condition is satisfied (YES in S22), the CPU 82 proceeds to S24. When the detachment condition is not satisfied (NO in S22), the CPU 82 returns to S20. When the CPU 82 determines "NO" in S22, the CPU 82 may notify the user that the detachment condition is not satisfied.

In S24, the CPU 82 executes a first detachment process. Specifically, the CPU 82 controls the operation of the moving device corresponding to the connected gas tank to move the connected gas tank from the disconnection position to the detachment position. The CPU 82 notifies the user that the first detachment process is completed. Thus, the user can detach the connected gas tank from the support 24A.

As described above, the gas supply system 2 includes the gas supply pipe 12 through which gas is supplied to the fuel cell 110 (an example of "gas use destination"), the gas tank 20A, the support 24A (an example of "tank attachment portion") configured such that the gas tank 20A is attachable and detachable, the moving device 26A that moves the gas tank 20A attached to the support 24A at least from the connection position to the detachment position, the switch 14A (an example of "operation portion") that receives an operation by a user, and the CPU 82 of the control device 80 that controls the operation of the moving device 26A. The connection position is a position where the gas tank 20A is connectable to the gas supply pipe 12. The detachment position is a position where the gas tank 20A is detachable from the support 24A. The CPU 82 controls the operation of the moving device 26A in response to the user's operation on the switch 14A.

With the above configuration, the moving device 26A can move the gas tank 20A to the detachment position in response to the user's operation on the switch 14A. Therefore, the user can detach the gas tank 20A from the support 24A at any time. Thus, the user convenience is improved. In addition, the gas tank 20A is prohibited from moving to the detachment position until the user operates the switch 14A. This suppresses the occurrence of a case where the gas tank 20A is accidentally detached from the support 24A or the gas tank 20A is stolen.

The gas supply system 2 includes the gas tanks 20A, 20B, the supports 24A, 24B, the moving devices 26A, 26B, and the switches 14A, 14B. The switches 14A, 14B are configured to receive user's operations for the moving devices 26A, 26B, respectively.

With the above configuration, the gas tanks 20A, 20B can be detached individually.

### Second Embodiment

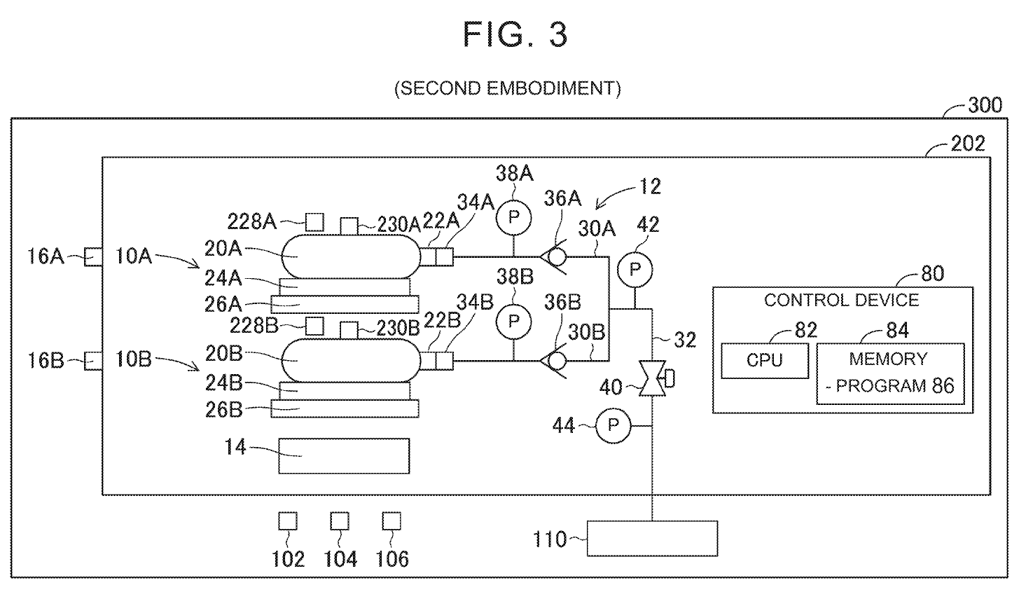

A vehicle 300 according to a second embodiment will be described with reference to FIG. 3. The vehicle 300 according to the second embodiment differs from the vehicle 100 according to the first embodiment in that the vehicle 300 includes a gas supply system 202. In the following, components common to the embodiments will be denoted by the same reference signs and descriptions thereof will be omitted.

As shown in FIG. 3, the gas supply system 202 includes temperature sensors 228A, 228B for detecting the ambient temperatures of the gas tanks 20A, 20B. Impact detection sensors 230A, 230B are attached to the gas tanks 20A, 20B, respectively, to detect impacts applied to the gas tanks 20A, 20B. In one example, the impact detection sensors 230A, 230B are acceleration sensors.

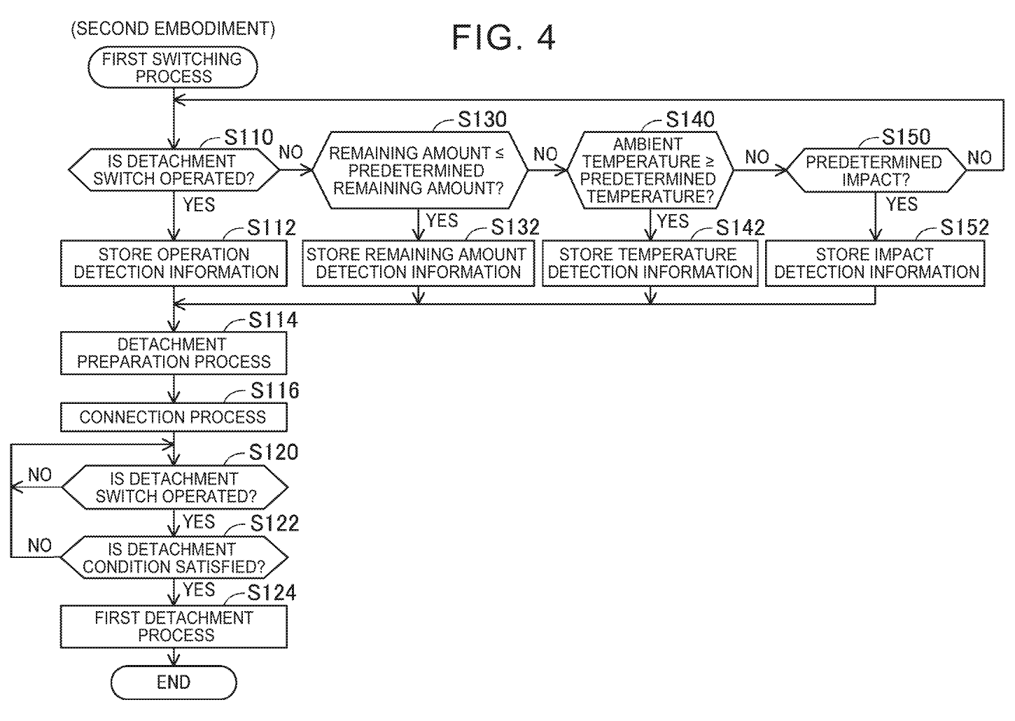

### First Switching Process: FIG. 4

A first switching process to be executed by the CPU 82 will be described with reference to FIG. 4. At the start of the process in FIG. 4, one of the gas tanks 20A, 20B is in the connection position, and the other is in the disconnection position.

In S110, the CPU 82 monitors whether an operation is received on the detachment switch corresponding to the connected gas tank. When an operation is received on the detachment switch, the CPU 82 determines "YES" in S110 and proceeds to S112.

In S112, the CPU 82 stores, in the memory 84, operation detection information indicating that an operation on the detachment switch is detected.

In S114, the CPU 82 executes the detachment preparation process. The CPU 82 notifies the user about information corresponding to the operation detection information and that the detachment preparation process for the connected tank is completed.

S116, S120, S122, and S124 are the same as S14, S20, S22, and S24 in FIG. 2, respectively.

Simultaneously with the monitoring in S110, the CPU 82 monitors in S130 whether the remaining amount in the connected gas tank is equal to or smaller than the predetermined remaining amount. When the remaining amount is equal to or smaller than the predetermined remaining amount, the CPU 82 determines "YES" in S130 and proceeds to S132.

In S132, the CPU 82 stores, in the memory 84, remaining amount detection information indicating the detection that the remaining amount is equal to or smaller than the predetermined remaining amount. When S132 ends, the CPU 82 proceeds to S114. In S114 after S132, the CPU 82 notifies the user about information corresponding to the remaining amount detection information and that the detachment preparation process for the connected tank is completed.

Simultaneously with the monitoring in S110 and S130, the CPU 82 monitors in S140 whether the ambient temperature of the connected gas tank is equal to or higher than a predetermined temperature. When the ambient temperature is equal to or higher than the predetermined temperature, the CPU 82 determines "YES" in S140 and proceeds to S142. In a modification, the CPU 82 may monitor whether an average value of the ambient temperatures of the connected gas tank within a predetermined period is equal to or higher than the predetermined temperature.

In S142, the CPU 82 stores, in the memory 84, temperature detection information indicating the detection that the ambient temperature is equal to or higher than the predetermined temperature. When S142 ends, the CPU 82 proceeds to S114. In S114 after S142, the CPU 82 notifies the user about information corresponding to the temperature detection information and that the detachment preparation process for the connected tank is completed.

Simultaneously with the monitoring in S110, S130, and S140, the CPU 82 monitors in S150 whether a predetermined impact has been applied to the connected tank using an impact sensor corresponding to the connected tank. When the predetermined impact is applied to the connected tank, the CPU 82 determines "YES" in S150 and proceeds to S152.

In S152, the CPU 82 stores, in the memory 84, impact detection information indicating the detection that the predetermined impact is applied to the connected tank. When S152 ends, the CPU 82 proceeds to S114. In S114 after S152, the CPU 82 notifies the user about information corresponding to the impact detection information and that the detachment preparation process for the connected tank is completed.

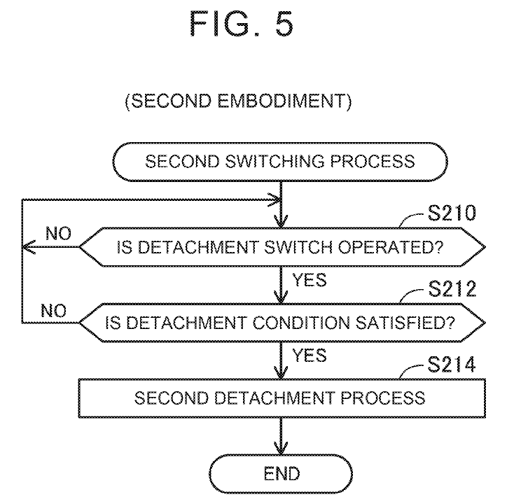

### Second Switching Process: FIG. 5

A second switching process to be executed by the CPU 82 will be described with reference to FIG. 5. The second switching process is a process corresponding to the disconnected gas tank. The CPU 82 executes the process in FIG. 5 in parallel with the process in FIG. 4.

In S210, the CPU 82 monitors whether an operation is received on the detachment switch corresponding to the disconnected tank. When an operation is received on the detachment switch, the CPU 82 determines "YES" in S210 and proceeds to S212.

S212 is the same as S22 in FIG. 2.

In S214, the CPU 82 executes a second detachment process. Specifically, the CPU 82 controls the operation of the moving device corresponding to the disconnected gas tank to move the disconnected gas tank from the disconnection position to the detachment position. Thus, the user can remove the disconnected gas tank from the vehicle 300. The CPU 82 notifies the user that the second detachment process is completed. When S214 ends, the CPU 82 ends the process in FIG. 5.

As described above, when the gas tank 20A is connected to the gas supply pipe 12 while the user operates the switch 14A, the CPU 82 disconnects the gas tank 20A from the gas supply pipe 12 (YES in S110, S114). When the gas tank 20A is disconnected from the gas supply pipe 12, the CPU 82 controls the moving device 26A to move the gas tank 20A to the detachment position (YES in S120, S124).

With the above configuration, the gas tank 20A can be moved stepwise in response to the user's operation on the switch 14A.

In a state in which the gas tank 20A is connected to the gas supply pipe 12, the CPU 82 disconnects the gas tank 20A from the gas supply pipe 12 (S114) when the remaining amount in the gas tank 20A is equal to or smaller than the predetermined amount (YES in S130), the ambient temperature of the gas tank 20A is equal to or higher than the predetermined temperature (YES in S140), or the predetermined impact is applied to the gas tank 20A (YES in S150).

It is not desirable to continue using the gas tank 20A when the remaining amount in the gas tank 20A is equal to or smaller than the predetermined amount, the ambient temperature of the gas tank 20A is equal to or higher than the predetermined temperature, or the predetermined impact is applied to the gas tank 20A. With the above configuration, the use of the gas tank 20A can be suppressed when the remaining amount in the gas tank 20A is equal to or smaller than the predetermined amount, the ambient temperature of the gas tank 20A is equal to or higher than the predetermined temperature, or the predetermined impact is applied to the gas tank 20A.

The gas supply system 2 is mounted on the vehicle 300 (an example of a "mobile body"). When at least one of the position, speed, and acceleration of the vehicle 300 satisfies the predetermined condition (NO in S122), the CPU 82 restricts the operation of the moving device 26A regardless of the user's operation on the switch 14A.

It is not desirable for the gas tank 20A to be detached from the support 24A when the vehicle 300 is located at a position different from the predetermined position. With the above configuration, it is possible to suppress the occurrence of a case where the gas tank 20A is detached from the support 24A when the vehicle 300 is located at a position different from the predetermined position.

When the gas tank 20A moves to the detachment position while the vehicle 300 is traveling, the gas tank 20A may be accidentally detached from the support 24A. With the above configuration, it is possible to suppress the occurrence of a case where the gas tank 20A is accidentally detached from the support 24A.

Although specific examples of the disclosure have been described in detail above, the examples are merely examples and do not limit the scope of claims. The technology described in the claims includes various modifications and variations of the specific examples described above.

### First Modification

In the second embodiment, when an operation is received on the switch corresponding to the connected gas tank, the CPU 82 may move the connected gas tank from the connection position to the detachment position.

### Second Modification

In the second embodiment, at least one of the processes of S130, S140, and S150 may be omitted.

### Third Modification

In the first embodiment, S22 in FIG. 2 may be omitted. In the second embodiment, S122 in FIG. 4 and S212 in FIG. 5 may be omitted.

### Fourth Modification

The CPU 82 may determine that the detachment condition is satisfied when at least one of the conditions corresponding to the speed, acceleration, and position information is satisfied in S22 in FIG. 2, S122 in FIG. 4, or S212 in FIG. 5.

### Fifth Modification

The gas supply system 2, 202 may include one gas tank unit, or may include three or more gas tank units.

### Sixth Modification

The gas supply system 2, 202 may include a cover that protects each of the switches 14A, 14B.

### Seventh Modification

The CPU 82 may determine "YES" in S20 in FIG. 2 or S110 or S120 in FIG. 4 when the switch is held down in S20 in FIG. 2 or S110 or S120 in FIG. 4.

### Eighth Modification

The gas supply system 2, 202 may include only one switch.

### Ninth Modification

The gas supply system 2, 202 may include an image sensor. In the present modification, the CPU 82 may determine in S122 in FIG. 4 whether the detachment condition is satisfied using an image captured by the image sensor.

### Tenth Modification

The CPU 82 may be configured to periodically transmit the speed, acceleration, and position information to an external device (server, terminal device). In the present modification, the CPU 82 transmits a signal to the external device to request transmission of information on whether the detachment condition is satisfied in S20 in FIG. 2 or S110 or S120 in FIG. 4. When the information received from the external device indicates that the detachment condition is satisfied, the CPU 82 determines "YES" in S20 or in S110 or S120 in FIG. 4.

### Eleventh Modification

The disconnection position may include a first disconnection position and a second disconnection position. The second disconnection position is closer to the detachment position than the first disconnection position. In the present modification, the disconnected gas tank is in the first disconnection position. The CPU 82 moves the connected gas tank from the connection position to the second disconnection position in the detachment preparation process (S12 in FIG. 2, S114 in FIG. 4).

### Twelfth Modification

The gas supply system 2, 202 may be mounted on a stationary power generation device.

The technical elements described in the present specification or in the drawings exhibit technical usefulness alone or in various combinations, and are not limited to the combinations described in the claims at the time of filing the application. In addition, the technology illustrated in the present specification or in the drawings may simultaneously achieve a plurality of objects, and the achievement of any one of the objects alone provides technical usefulness.

What is claimed is:

1. A gas supply system comprising:
a gas supply pipe through which gas is supplied to a gas use destination;
a gas tank;
a tank attachment portion configured such that the gas tank is attachable and detachable;
a moving device configured to move the gas tank attached to the tank attachment portion at least from a connection position to a detachment position;
an operation portion configured to receive an operation by a user; and
a control device configured to control an operation of the moving device, wherein:
the connection position is a position where the gas tank is connectable to the gas supply pipe, and the detachment position is a position where the gas tank is detachable from the tank attachment portion; and
the control device is configured to control the moving device in response to an operation on the operation portion by the user.

2. The gas supply system according to claim 1, wherein the control device is configured to, in response to the operation on the operation portion by the user,
disconnect the gas tank from the gas supply pipe when the gas tank is connected to the gas supply pipe, and
control the moving device to move the gas tank to the detachment position when the gas tank is disconnected from the gas supply pipe.

3. The gas supply system according to claim 2, wherein the control device is configured to disconnect the gas tank from the gas supply pipe when a remaining amount in the gas tank is equal to or smaller than a predetermined amount, an ambient temperature of the gas tank is equal to or higher than a predetermined temperature, or a predetermined impact is applied to the gas tank in a state in which the gas tank is connected to the gas supply pipe.

4. The gas supply system according to claim 1, wherein:
the gas supply system is mounted on a mobile body; and
the control device is configured to restrict the operation of the moving device regardless of the operation on the operation portion by the user when at least one of a position, a speed, and an acceleration of the mobile body satisfies a predetermined condition.

5. The gas supply system according to claim 1, wherein:
the gas supply system includes:
a plurality of the gas tanks;
a plurality of the tank attachment portions corresponding to the gas tanks, respectively;
a plurality of the moving devices corresponding to the gas tanks, respectively; and
a plurality of the operation portions corresponding to the gas tanks, respectively; and
the operation portions are configured to receive operations by the user for the moving devices, respectively.
